(19) United States
(12) Patent Application Publication
(10) Pub. No.: US 2015/0233819 A1
(43) Pub. Date: Aug. 20, 2015

(54) POSITIONING APPARATUS, PROCESSING APPARATUS USING THE SAME, AND POSITIONING METHOD AND PROCESSING METHOD USING THE SAME

(71) Applicant: GWANGJU INSTITUTE OF SCIENCE AND TECHNOLOGY, Gwangju (KR)

(72) Inventors: Yong-Gu LEE, Gwangju (KR); Muhammad WALEED, Gwangju (KR)

(21) Appl. No.: 14/580,709

(22) Filed: Dec. 23, 2014

(30) Foreign Application Priority Data
Feb. 14, 2014 (KR) 10-2014-0017390

(51) Int. Cl. G01N 21/47; G21K 5/10

(52) U.S. Cl. CPC G01N 21/47; G21K 5/10; G01N 2201/061; G01N 2201/02

(57) ABSTRACT

A positioning apparatus, a processing apparatus using the same, and a positioning method and a processing method using the same. The positioning apparatus includes a substrate to which a particle is provided, a trapping light source providing trapping light to trap the particle, a positioner adjusting a distance between the particle and the substrate, and a photodetector measuring a change in intensity of scattered light depending upon deviation of a focus of the trapping light from the particle. According to the present invention, it is possible to process an object with nanoscale precision. In addition, the positioning apparatus and the processing apparatus can be composed of simple and small devices with high processing accuracy.

### CROSS REFERENCE TO RELATED APPLICATION

This application claims the benefit of Korean Patent Application No. 10-2014-0017390, filed on Feb. 14, 2014, entitled “POSITIONING APPARATUS, PROCESSING APPARATUS USING THE SAME, AND POSITIONING METHOD AND PROCESSING METHOD USING THE SAME”, which is hereby incorporated by reference in its entirety into this application.

### BACKGROUND

1. Technical Field

The present invention relates to a positioning apparatus, a processing apparatus using the same, and a positioning method and a processing method using the same. More particularly, the present invention relates to an apparatus for accurately positioning and processing an object in nanoscale using lasers.

2. Description of the Related Art

Nanoscale objects have been known to be difficult to precisely measure and process. For example, measurement of nanoscale objects can make it possible to inject a specific substance into a cell by processing the surface of the cell, and can be widely used as technologies required for accurately processing the surface or inside of objects. Although technologies well-known in the art can be used to position or process the surface of micron-scale objects, the technologies do not provide nanoscale precision.

Optical tweezers have been introduced to move or arrange atoms, molecules, or cells in a predetermined pattern. The optical tweezers are based on the fact that nano-particles can be moved using light having properties of trapping an object.

The inventor of the present invention has devised the present invention through investigation as to whether the optical tweezers can be used to position or process objects.

### BRIEF SUMMARY

Embodiments of the present invention provide a positioning apparatus, a processing apparatus using the same, and a positioning method and a processing method using the same, which can accurately position an object in nanoscale and precisely process a surface or the inside of the object.

In accordance with one aspect of the present invention, a positioning apparatus includes: a substrate to which a particle is provided; a trapping light source providing trapping light to trap the particle; a positioner adjusting a distance between the particle and the substrate; and a photodetector measuring a change in intensity of scattered light depending upon deviation of a focus of the trapping light from the particle. According to the present invention, an object can be accurately positioned.

The positioning apparatus may further include an objective lens focusing the trapping light on the particle, wherein the positioner may move the objective lens. Accordingly, it is possible to conveniently move the particle. The photodetector may include a quadrature photodiode (QPD), thereby accurately measuring a location of a particle in three-dimensions. The positioning apparatus may further include at least one of a camera for capturing the scattered light and an observerscope for observing the scattered light, thereby enhancing user convenience and allowing identification of accuracy. The observerscope is a device that converts two-dimensional profile of the incoming light (from ultraviolet to infrared spectrum) intensity to an image that can be safely seen through a naked eye. The trapping light source and the photodetector may all be positioned on one side or may be positioned on opposite sides of the substrate, respectively. Therefore, the entire system can be configured in various ways. The positioning apparatus may further include a controller controlling the trapping light source, the positioner, and the photodetector, wherein the controller may determine that the particle contacts the substrate, when the scattered light intensifies. Accordingly, it is possible to reliably identify an accurate location of a particle.

In accordance with another aspect of the present invention, a processing apparatus includes any one of the positioning apparatuses set forth above and a processing light source providing processing light to process at least one of the substrate and the particle. Accordingly, it is possible to conveniently process a positioned object with precision.

A light path of the processing light may be at least partially coincident with that of the trapping light, thereby achieving a simpler system and enhanced processing accuracy.

In accordance with a further aspect of the present invention, a positioning method includes: moving a particle using trapping light; and recognizing stoppage of the particle due to contact with an object, by observing a change in scattered light caused by scattering of the trapping light from the particle. Accordingly, it is possible to accurately position the particle and the object corresponding to the particle. The stoppage of the particle may be sensed based on increase in intensity of scattered light, thereby accurately positioning the particle.

In accordance with yet another aspect of the present invention, a processing method includes recognizing contact of a particle with an object based on the positioning method as set forth in claim 9 or 10, followed by irradiating processing light for processing at least one of the particle and the object. Accordingly, it is possible to precisely process the positioned object and particle.

According to embodiments of the present invention, it is possible to accurately position an object in nanoscale and to achieve precise processing of the object with reference to positioning information.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 shows a positioning apparatus and a processing apparatus using the same according to a first embodiment of the invention;

FIG. 2 shows a particle trapped by trapping light;

FIG. 3 shows photodetector outputs depending upon movement of a focus relative to the particle center;

FIG. 4 shows an operating principle of the processing apparatus using the positioning apparatus;

FIG. 5 is a graph showing intensity of scattered light sensed by a photodetector;

FIG. 6 is a flowchart showing a processing method using a positioning method according to one embodiment of the present invention; and

FIG. 7 shows a positioning apparatus and a processing apparatus using the same to according to a second embodiment of the invention.

### DETAILED DESCRIPTION

Hereinafter, exemplary embodiments of the present invention will be described in detail with reference to the accompanying drawings. However, the present invention should not be construed as being limited to the embodiments set forth herein. While those skilled in the art can readily devise other embodiments within the spirit and scope of the present invention through addition, modification, or deletion of components, such embodiments may fall within the scope of the present invention.

Although components may be different from desirable ones in size and shape in the drawings illustrating the embodiments, the components will be simply shown for convenience of description.

### Embodiment 1

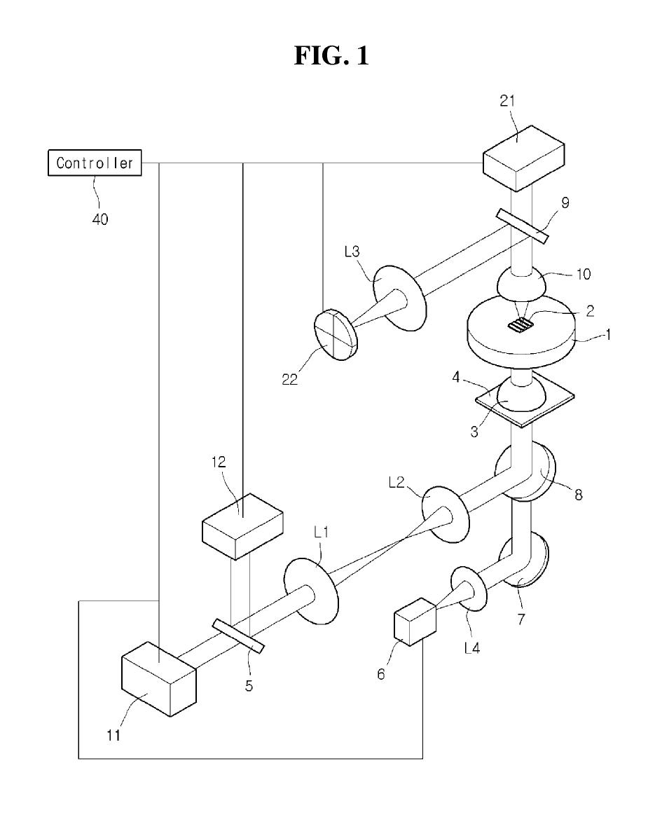

FIG. 1 shows a positioning apparatus and a processing apparatus using the same according to a first embodiment of the invention.

Referring to FIG. 1, a stage 1 is provided such that a substrate 2 can be placed thereon. The substrate 2 may be an object for which positioning is required. Positioning may include information on the height of the object at a specific location thereof and information on a three-dimensional structure of the object obtained by collecting such information on the height of the object. A particle may be provided to the substrate 2. The particle may be exemplified as a single cell. The object may be positioned or processed by controlling movement of the particle.

An objective lens 3 is disposed below the stage 1 and provided with an objective lens positioner 4 capable of moving the objective lens 3 in three dimensions. The objective lens 3 may move relative to the substrate 2.

A structure is further provided to irradiate light, for example, a laser beam, toward the objective lens 3. Specifically, the structure includes a first light source 11 emitting, for example, a near infrared (NIR) laser beam, a second light source 12 emitting, for example, a carbon dioxide (CO₂) laser beam, and a first dichroic mirror 5 for at least partially harmonizing light paths of the first and second light sources 11, 12. In addition, the structure may further include a second dichroic mirror 8 reflecting the laser beams, emitted from the light sources 11, 12, toward the objective lens. Here, the first light source 11 may be used as a light source for trapping a particle using optical tweezers, and the second light source 12 may be used as a light source for processing an object. To this end, the first and second light sources may be referred to as a trapping light source and a processing light source, respectively.

When trapping light emitted from the first light source is irradiated to the substrate 2, a particle on the substrate 2 may be trapped. The trapped particle may move together with the objective lens positioner 4. When the particle contacts the surface of the substrate 2 during movement, the particle cannot move any more. Thereafter, when the objective lens positioner 4 moves further, the focus of the trapping light deviates from a central portion of the particle. At this time, a pattern of scattered light caused by scattering of the trapping light from the particle varies with movement of the focus of the light, emitted from the first light source 11, with respect to the particle. The scattered light, caused by collision of the light with the particle, may be changed in intensity and pattern depending on the way incident light collides with the particle.

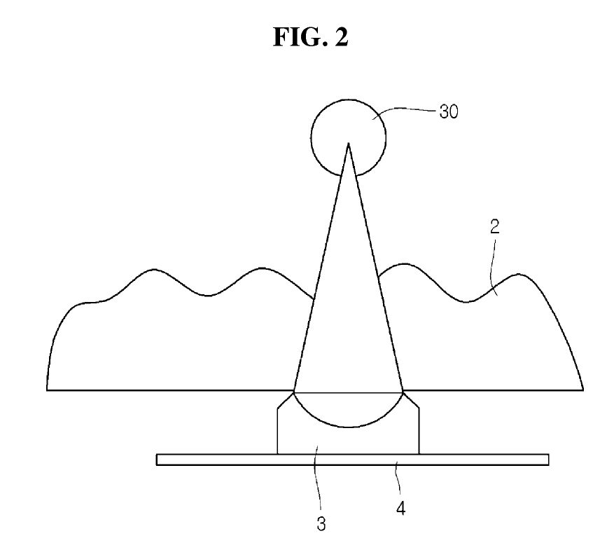

FIG. 2 shows a particle trapped by trapping light. Referring to FIG. 2, when trapping light is irradiated through the objective lens 3, a particle near the focus of the trapping light is trapped. Such a phenomenon has been well-known as optical tweezers. At this time, the trapping light is focused on the center of the trapped particle.

Referring again to FIG. 1, devices may be further provided to sense a difference in light scattering from the particle. Specifically, the devices include a condenser lens 10 for collecting light scattering from the substrate 2, namely, the particle, and a photodiode 22 for sensing the light collected by the condenser lens 10. The photodiode 22 may include a quadrature photodiode (QPD) as a photodetector. The photodiode may also be referred to as a photodetector. Four photodiodes 22 may be used to identify a degree of particle movement in horizontal and vertical axis directions by sensing variation in intensity of light in those directions and a degree of particle movement in a depth direction by sensing the degree of spreading of light from the center of the QPD.

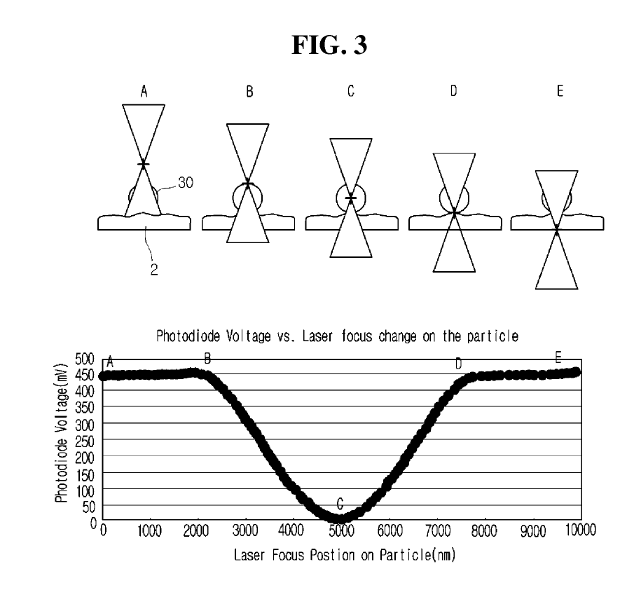

FIG. 3 shows photodetector outputs depending upon movement of a focus of trapping light relative to the particle center. Referring to FIG. 3, it is assumed that a particle 30 is attached to the substrate 2 and trapping light vertically moves upwards or downwards. The photodetector 22 produces the least output when the trapping light is focused on the center of the particle 30 and the output of the photodetector gradually increases as the focus of the trapping light deviates from the center of the particle since the trapping light scatters on the particle.

Referring again to FIG. 1, components may be further provided to sense scattered light using the naked eye or a camera. For example, a third dichroic mirror 9 may be provided between the condenser lens 10 and the photodiode 22, and an observerscope 21 may be provided near the third dichroic mirror 9. The scattered light may be observed with the naked eye through the observerscope 21. Branching from the second dichroic mirror 8, the light scattered from the particle may be captured through a mirror 7 and a camera 6.

The positioning apparatus may be provided according to the configuration as described above. Specifically, while sensing a change in intensity of scattered light during contact of the particle 30 with the substrate 2, the positioning apparatus can identify a surface location of an object, namely, the substrate 2 at a point the particle is present, by recognizing a location of the objective lens positioner 4 when the trapping light deviates from the particle 30. In addition, such a process may be repetitively performed on all points on the substrate 2 in two or three-dimensions, thereby making it possible to accurately determine the location of the surface of the object.

A controller is further provided to control the components described above. It will be understood that the controller further includes communication, storage, and operation functions.

The positioning apparatus may be configured only with the components described above.

Referring again to FIG. 1, a processing apparatus using the positioning apparatus according to the embodiment of the invention further includes the second light source 12. As described above, the second light source may be provided as the processing light source. Processing light may be irradiated when the focus of the trapping light reaches the surface of the substrate 2. That is, the processing light may be irradiated in “D” state in FIG. 3. Then, the surface of the particle or substrate can be precisely processed by accurate transfer of energy thereto. In another example, the positioner may be further moved downwards to process the inside of the substrate or upward to process the inside of the particle between “B” and state “C” states in FIG. 3.

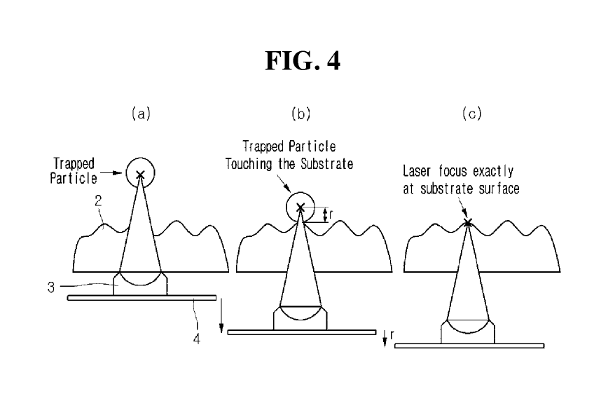

FIG. 4 shows an operating principle of the processing apparatus using the positioning apparatus.

Referring to FIG. 4, the particle 30 is trapped by irradiating trapping light through the objective lens 3 (FIG. 4 (a)). The trapped particle 30 is moved to the substrate 2 by the objective lens positioner 4 to contact the substrate (FIG. 4 (b)). The particle 30 is further moved by a radius (r) of the particle to the substrate 2 (FIG. 4 (c)). In consequence, the trapping light may be accurately focused on the surface of the substrate 2.

In the state shown in FIG. 4 (c), the surface of the substrate 2 may be precisely processed by irradiation of processing light thereto.

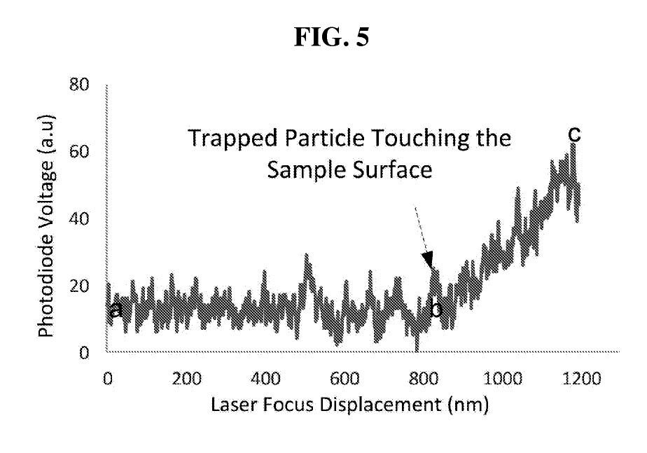

FIG. 5 is a graph showing intensity of scattered light sensed by a photodetector. Referring to FIG. 5, it can be seen that the intensity of scattered light is constant from state “a” to state “b” and gradually increases from state “b” to state “c”. In state “c”, the surface of the substrate 2 is processed by irradiating processing light.

In this embodiment, observation with the naked eye and the camera can be excluded. In this case, positioning and processing can be precisely performed using a photodetector, for example, the photodiode 22.

According to the embodiment, a surface of an object can be precisely measured and the object can be precisely processed in nanoscale. In addition, the apparatus can also be sufficiently implemented on a small scale. Descriptions of some lenses shown in the drawings will be omitted.

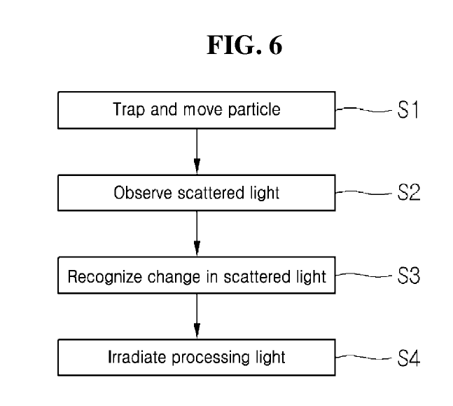

FIG. 6 is a flowchart showing a processing method using a positioning method according to one embodiment of the present invention.

Referring to FIG. 6, a nanoscale particle is moved using optical tweezers (S1). A change in intensity of scattered light is observed while moving the particle using optical tweezers (S2). The intensity of the scattered light is gradually increased from when the particle cannot move any more on account of contact with an obstacle. In other words, although the particle cannot move any more due to the contact with the obstacle, the focus of trapping light continues to move. At this time, the intensity of the scattered light is gradually increased as the focus of the trapping light deviates from the center of the particle. Accordingly, it can be identified that the intensity of the scattered light starts to increase when the particle contacts the obstacle, namely, the object to be processed (S3). The changing pattern of the intensity of the scattered light may be used as information for positioning or processing an object.

After the particle contacts the object, the trapping light is focused on the surface of the object by moving the focus of the trapping light by a radius of the particle, and then the object may be processed by irradiating processing light thereto (S4).

The method of positioning the object may be performed by carrying out operation S3 of recognizing the change in the intensity of the scattered light. In addition, the processing method using the positioning method may be performed by carrying out operation S4 of processing the object by irradiating the processing light.

According to the methods, the object can be precisely positioned and processed in nanoscale.

### Embodiment 2

A second embodiment of the present invention is different from the first embodiment in that a direction of incident light is the same as that of measuring light. Herein, the difference therebetween will be described in detail, and descriptions of the features to which the first embodiment can be applied as is will be omitted.

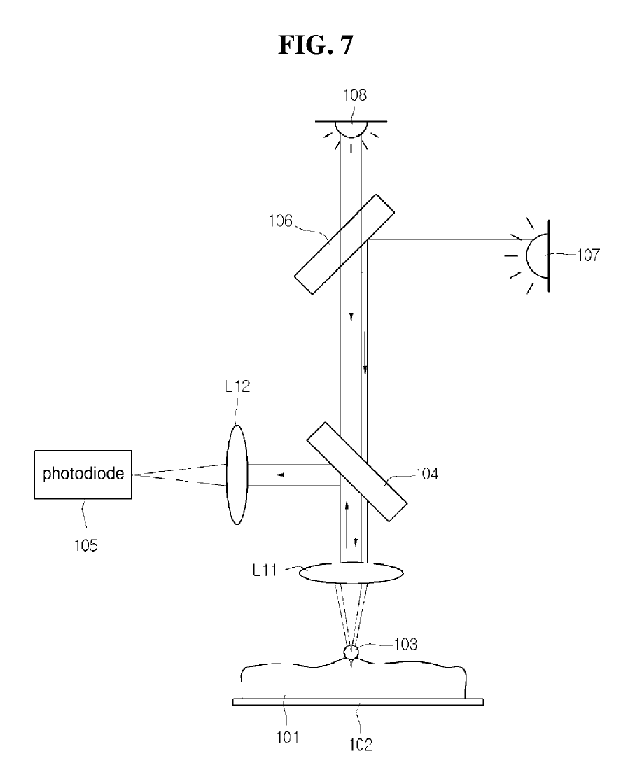

FIG. 7 shows a positioning apparatus and a processing apparatus using the same according to the second embodiment of the invention.

Referring to FIG. 7, a substrate 101 is placed on a movable positioner 102 and a particle 103 is placed on the substrate 101. The particle may be movable on the substrate 101.

A first light source 108 is provided to irradiate trapping light for trapping the particle 103. After the first light source 108 traps the particle 103 with optical tweezers, a gap between the substrate 101 and the particle 103 may be gradually decreased by moving the positioner 102. Scattered light caused by a change in location between the focus of the trapping light and the center of the particle 103 has low intensity while the focus of the trapping light matches the center of the particle 103, and the intensity of the scattered light is gradually increased as the focus of the trapping light deviates from the center of the particle on account of contact of the particle 103 with the substrate 101. The scattered light is input to a photodiode 105 through a dichroic mirror 104 and converted into an electrical signal.

When the scattered light starts to change in intensity, the positioner 102 may be further moved by a radius of the particle, and then, the surface of the substrate 101 may be processed by irradiating processing light emitted from a second light source 107 as a processing light source. In addition, the inside of the substrate 101 may also be processed by further moving the positioner 102.

A dichroic mirror 106 may be additionally provided to harmonize light paths of the first and second light sources 108, 107.

Although the positioner 102 is moved in the above description, another positioner may also be configured to move the light sources and the photodiode 105 while the positioner 102 is fixed.

According to the second embodiment, the photodetector and the light sources are provided on the same side with respect to the substrate, thereby further simplifying the structure of the apparatus.

What is claimed is:

1. A positioning apparatus comprising:
a substrate to which a particle is provided;
a trapping light source providing trapping light to trap the particle;
a positioner adjusting a distance between the particle and the substrate; and
a photodetector measuring a change in intensity of scattered light depending upon deviation of a focus of the trapping light from the particle.

2. The positioning apparatus according to claim 1, further comprising:
an objective lens focusing the trapping light on the particle,
wherein the positioner moves the objective lens.

3. The positioning apparatus according to claim 1, wherein the photodetector comprises a quadrature photodiode (QPD).

4. The positioning apparatus according to claim 1, further comprising:
at least one of a camera for capturing the scattered light and an observerscope for observing the scattered light with the eye.

5. The positioning apparatus according to claim 1, wherein the trapping light source and the photodetector are all positioned on one side or are positioned on opposite sides of the substrate, respectively.

6. The positioning apparatus according to claim 1, further comprising:
a controller controlling the trapping light source, the positioner, and the photodetector,
wherein the controller determines that the particle contacts the substrate when the scattered light intensifies.

7. A processing apparatus including the positioning apparatus according to any one of claims 1, the processing apparatus comprising:
a processing light source providing processing light to process at least one of the substrate and the particle.

8. The processing apparatus according to claim 7, wherein a light path of the processing light is at least partially coincident with that of the trapping light.

9. A positioning method comprising:
moving a particle using trapping light; and
recognizing stoppage of the particle due to contact with an object, by observing a change in scattered light caused by scattering of the trapping light from the particle.

10. The positioning method according to claim 9, wherein the stoppage of the particle is sensed based on increase in intensity of scattered light.

11. A processing method comprising:
recognizing contact of a particle with an object based on the positioning method according to claim 9, followed by irradiating processing light for processing at least one of the particle and the object.

12. A processing method comprising:
recognizing contact of a particle with an object based on the positioning method according to claim 10, followed by irradiating processing light for processing at least one of the particle and the object.
